(19) United States
(12) Patent Application Publication
(10) Pub. No.: US 2025/0088437 A1
(43) Pub. Date: Mar. 13, 2025

(54) X-CENTRIC COMMUNICATION INFRASTRUCTURE FOR SUPPORTING ANYTHING-AS-A-SERVICE SERVICE MODEL

(71) Applicant: HUAWEI TECHNOLOGIES CO., LTD., SHENZHEN (CN)

(72) Inventors: Hang ZHANG, Kanata (CA); Xu LI, Kanata (CA)

(73) Assignee: HUAWEI TECHNOLOGIES CO., LTD., SHENZHEN (CN)

(21) Appl. No.: 18/960,420

(22) Filed: Nov. 26, 2024

Related U.S. Application Data
(63) Continuation of application No. PCT/CN2023/080218, filed on Mar. 8, 2023.
(60) Provisional application No. 63/347,365, filed on May 31, 2022.

(51) Int. Cl. H04L 41/5051; H04L 41/40

(52) U.S. Cl. CPC H04L 41/5051; H04L 41/40

(57) ABSTRACT

A method, apparatus and system providing an open system architecture, referred to as X-centric architecture, that offers, supports or enables anything-as-a-service (XaaS) and can be centric to a variety of roles to support various operation scenarios. A service supported by the X-centric architecture is referred to as an XaaS service. Embodiments of the X-centric architecture involve a modular design which is extensible and adaptable. Embodiments provide or facilitate a new service module to be added dynamically to offer, support or enable XaaS services without the need to modify or redesign the system architecture.

### CROSS-REFERENCE TO RELATED APPLICATIONS

This application is a continuation of International Application No. PCT/CN2023/080218, filed on Mar. 8, 2023, which claims the benefit of the prior-filed provisional patent application in the United States, with Application No. 63/347,365 filed on May 31, 2022 and titled “X-CENTRIC COMMUNICATION INFRASTRUCTURE FOR SUPPORTING ANYTHING-AS-A-SERVICE SERVICE MODEL”, the contents of which are incorporated herein by reference in their entirety.

### TECHNICAL FIELD

This invention pertains generally to the field of computerized communication systems and in particular to communication infrastructures for implementing anything-as-a-service (XaaS) service delivery.

### BACKGROUND

Current wireless communication systems (also referred to as wireless systems), such as 5^{th} Generation (5G) systems as defined by the 3^{rd} Generation Partnership Project (3GPP) are designed to provide connectivity services. It is anticipated that future wireless systems (e.g. 6^{th} Generation (6G) systems as defined by the 3GPP) will go beyond connectivity provisioning to offer various new services. It is also anticipated the future wireless system may be operated by multiple parties, for example with different parties operating a different portion of the wireless system to offer certain services. These services may be provided for the system's (e.g. operating party's) internal use or for an end customer's use.

However, current wireless systems and infrastructure require further development to support the above scenario and comparable scenarios. Such development is not straightforward and can require solving of a variety of technical and design problems.

Therefore, there is a need for a method, apparatus and system for implementing an XaaS service delivery, that obviates or mitigates one or more limitations in the prior art.

This background information is intended to provide information that may be of possible relevance to the present disclosure. No admission is necessarily intended, nor should be construed, that any of the preceding information constitutes prior art against the present disclosure.

### SUMMARY

Embodiments of the present disclosure provide for an open system architecture for wireless systems that offers anything-as-a-service (XaaS) functionality. Embodiments can be centric to any one of a variety of roles to support various operation scenarios, a feature that is referred to as being an X-centric architecture. Furthermore, embodiments can be provided as an open system architecture. Embodiments may be extensible, allowing unknown future services to be dynamically enabled or offered, substantially without the need to modify or redesign the system architecture. To facilitate this, the X-centric architecture can be provided using a modular design, as described herein. A service supported by the X-centric architecture can be referred to as an XaaS service. The modular design may allow a new service module to be added dynamically to enable or offer or support an associated new XaaS service.

In accordance with an embodiment of the present disclosure, there is provided a system for example formed at least in part from multiple networked computing devices of a networked communication system, each having at least a processor, a network interface, and a memory. The system includes one or more infrastructure modules, one or more service modules, and one or more management and control modules, each instantiated for example using one or more of the networked computing devices. The infrastructure modules each provide a respective infrastructure resource as service. Each infrastructure resource may include a respective type of device for supporting the networked communication system. The service modules each provide a respective functionality as service and utilizing at least one of the infrastructure resources as service. The management and control modules each provide a respective management or control resource (also referred to as function) as service. At least one, or each, of the management and control modules may utilize services of at least one of the infrastructure modules. At least one of the management and control modules may provide its respective management or control resource (or function) as service to at least one of the infrastructure modules or the service modules.

In various embodiments, the one or more (or plurality of) service modules includes a connectivity service module configured to provide a connectivity service, the one or more (or plurality of) management and control modules includes a mission management module configured to provide a mission management service, or both.

In some embodiments, each one of the service modules includes its own respective service management and control plane component, and each one of the infrastructure modules includes its own respective infrastructure management and control plane component. The management and control modules, the service management and control plane components, and the infrastructure management and control plane components in such embodiments are operatively coupled together via interconnections. The interconnections may form a full mesh network.

In some embodiments, the management and control modules are operatively coupled to one another via interconnections. In some further embodiments, the service modules and the infrastructure modules are operatively coupled to one another and to the management control modules via said interconnections. The interconnections may form a full mesh network or communication bus. The interconnections may be managed by the connectivity service module or the mission management module.

In some embodiments, at least one of the service modules includes a service management and control plane component and a service data plane component operatively coupled to the service management and control plane component. The service management and control plane component may be provided at least in part using one or more of said management and control modules as service. The service data plane component may be provided at least in part using two of more of said infrastructure modules as service. Two or more of the service data plane components of two or more of the service modules may be communicatively coupled together via respective interconnections, such as tunnels. The interconnections may be managed by the connectivity service module, the mission management module, or a combination thereof.

In some embodiments, at least one of the service modules is provided at least in part using two or more of the infrastructure modules as services. In some embodiments, the connectivity service module and the mission management module are integrated together.

In some embodiments, each one of the service modules includes its own respective service management and control plane component. In such embodiments, the service management and control plane components are operatively coupled together, or the management and control modules are operatively coupled together, or the service management and control plane components are operatively coupled to the management and control modules, or a combination thereof.

In some embodiments, at least one of the infrastructure modules provides its respective infrastructure resource as service to at least one of: another one of the infrastructure modules; and one of the management and control modules. In some embodiments, at least one of the service modules provides its respective functionality as service to at least one of: another one of the service modules; one of the infrastructure modules; and one of the management and control modules. In some embodiments, at least one of the management and control modules provides its respective management or control resource (or function) as service to another one of the management and control modules.

In some embodiments (e.g. according to an infrastructure-provider centric scenario), a same party provides or operates at least one of the infrastructure modules and at least one of the management and control modules. In some embodiments (e.g. according to a third-party centric scenario), a same party provides or operates a plurality or all of the management and control modules. In some embodiments (e.g. according to a customer centric scenario), a same party provides or operates at least one of the service modules and at least one of the management and control modules. In further embodiments, another party provides or operates at least one of the infrastructure modules, service modules, and management and control modules which is not provided or operated by the aforementioned same party.

In some embodiments, at least one of the service modules includes a service management and control component and a service data plane operatively coupled to the service management and control component. In some further embodiments, the service management and control component is provided at least in part using one or more of said management and control modules as service. Additionally or alternatively, the service data plane may be provided at least in part using one of more of said infrastructure modules as service. Additionally or alternatively, two or more of the service data planes may be communicatively coupled together via respective interconnections, such as tunnels.

In some embodiments, two or more of the service modules are communicatively coupled together via interconnections, such as tunnels.

In some embodiments, at least one of the infrastructure modules includes an infrastructure management and control component. The infrastructure management and control component may be provided at least in part using one or more of said management and control modules as service.

In some embodiments, at least one of the service modules includes a respective service management and control component, at least one of the infrastructure modules includes a respective infrastructure management and control component, or both. The management and control modules, the service management and control components, and the infrastructure management and control components may be communicatively coupled together, for example using a full mesh network or alternatively using a non-full mesh network.

In some embodiments, the infrastructure modules include one or more of: a terrestrial communication module; a non-terrestrial communication module; a cloud module; a caching module; a sensor module; a radio access network module; a core network module; a datacenter module; and a database module. In some embodiments, the service modules include one or more of: a network for artificial intelligence module; a network for data module; a network for blockchain module; a data analytics and management module; a module providing a vertical service; a connectivity service module; and a network for digital world module. In some embodiments, the management and control modules include one or more of: a resource management module; a protocol management module; a connectivity management module; a policy and customer service management module; a mission management module; a CONET module; a network security management module; a service provisioning management module; and a network security management module.

In various embodiments, at least one of the infrastructure modules, the service modules and the management and control modules operate in accordance with an open system architecture.

In various embodiments, the management and control modules include a mission management module configured to interoperate with one or more of the service modules to perform a specified mission, said mission comprising a specified set of tasks or operations. The mission management module may interoperate with two or more of the service modules to perform the specified mission, and the mission management module may cause one or more interconnections to be established between said two or more of the service modules in support of the specified mission. One or more terminals, application servers, or both, may be operatively coupled to one or more of the service modules and operate to support the specified mission.

In accordance with an embodiment of the present disclosure, there is provided a method, for example performed by one or a collection of networked computing devices. The method includes providing one or more infrastructure resources as service, using one or more respective infrastructure modules. Each infrastructure resource may include a respective type of device for supporting an associated networked communication system. The method further includes providing one or more functionalities as service, using one or more respective service modules. At least one service module utilizes at least one of the infrastructure resources as service. The method further includes providing one or more management or control resources (or functions) as service using one or more respective management and control modules. At least one of the management and control modules provides its respective management or control resource (or function) as service to at least one of the infrastructure modules or the service modules. The method may include one or more further aspects for example as discussed above with respect to a provided system.

In accordance with an embodiment of the present disclosure, there is provided a computer program product comprising a (e.g. non-transitory) computer readable medium having statements and instructions stored thereon which, when executed by one or more computer processors, cause the computer processors to perform the method as set forth above.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1A illustrates a system including service modules, management and control modules and infrastructure modules, in accordance with embodiments of the present disclosure.

FIG. 1B illustrates a system including service modules, management and control modules and infrastructure modules, in accordance with other embodiments of the present disclosure.

FIG. 2A illustrates a system in which one or more infrastructure providers provide both management and control modules and infrastructure modules, in accordance with embodiments of the present disclosure.

FIG. 2B illustrates a system in which a third party provides multiple management and control modules, in accordance with embodiments of the present disclosure.

FIG. 2C illustrates a system in which one or more customers provide both management and control modules and service modules, in accordance with embodiments of the present disclosure.

FIG. 3A illustrates a system including service modules, management and control modules and infrastructure modules, and contents and interconnections of such modules, in accordance with embodiments of the present disclosure.

FIG. 3B illustrates a system including service modules, management and control modules and infrastructure modules, and contents and interconnections of such modules, in accordance with other embodiments of the present disclosure.

FIG. 4 illustrates a computing device that may perform computing or related operations according to embodiments of the present disclosure.

It will be noted that throughout the appended drawings, like features are identified by like reference numerals.

### DETAILED DESCRIPTION

As used herein, the term “anything-as-a-service,” i.e. “XaaS” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe for example that the functionality of an arbitrary module disclosed herein can be provided as a service to another module or an external entity, such as a customer. The phrase “as service” is used herein to be synonymous with “as a service.”

An open system architecture may refer to a design approach in which systems (e.g. modules) are interoperable and interconnectable with one another, generally without requiring retrofit or redesign. An open system architecture is one approach for achieving a modular design in which modules are configured to be interoperable. An open system architecture can involve modules which are responsive in a known manner to known inputs, for example to perform actions or provide responses to queries, inputs or stimuli in a predictable (possibly standardized) manner. Modules in an open system architecture can provide functionalities as a service in that they respond to inputs or stimuli in a particular way, thus providing such functionalities. A service may be provided by a server to a client, and thus the “as service” model may involve a server-client model.

According to embodiments of the present disclosure, there is provided a networked computing and communication system comprising multiple different types of modules in an open system architecture. On one layer, infrastructure modules each provide a respective infrastructure resource as service. Infrastructure resources may include real computing, communication or data storage resources. On another layer, service modules each provide a respective functionality as service. Service module functionalities may be functionalities that can be utilized by an end user or other module. The service modules may utilize at least one of the infrastructure resources as service. On another layer, management and control modules each provide a respective management or control resource (or function) as service. Management and control resources may be used to manage other modules, missions of modules, module operations, or other management or control tasks. At least one of the management and control modules may provide its respective management or control resource (or function) as service to at least one of the infrastructure modules or the service modules. Each module may provide its functionality as a service, on an as-needed basis, to one, some or all modules of the same layer or of different layers. Modules can be interconnected to provide services to one another in a configurable manner depending on operational requirements. Different modules can be provided or operated by different parties, in order to provide for different X-centric configurations, which may be party-centric configurations.

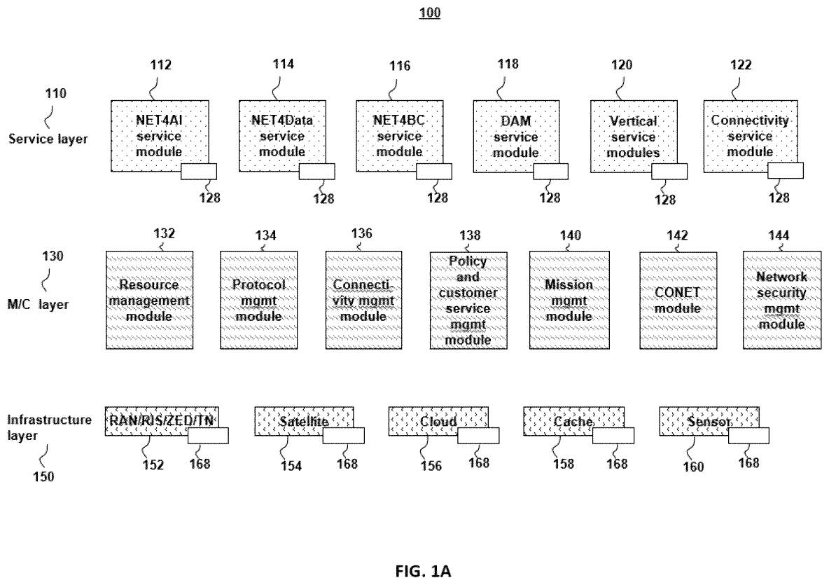

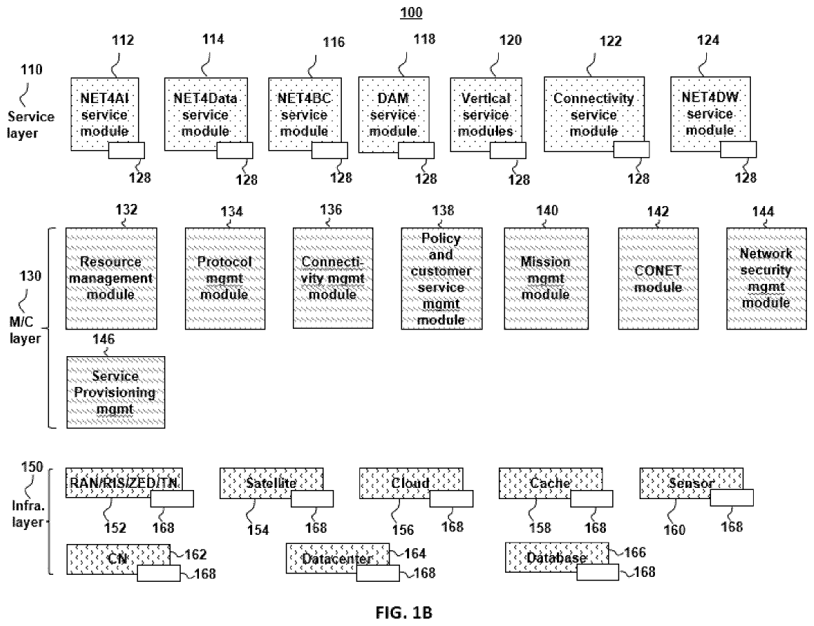

FIG. 1A illustrates an (e.g. X-centric) architecture provided in accordance with an illustrative embodiment of the present disclosure. The architecture 100 includes a service layer 110, a management and control (M/C) layer 130, and an infrastructure layer 150. Different layers may provide different services. Services of each layer are examples of different types of XaaS services. Accordingly, an architecture having three different layers, with XaaS modules in each layer, is provided, which may facilitate openness and extensibility.

The service layer 110 includes one or a plurality of service modules. Service modules can be included or excluded as required for a particular operating scenario. As new service modules are developed, they can be included into an existing architecture or implementation of the network.

By way of example, FIG. 1A illustrates a variety of possible service modules. These examples are not necessarily intended to be limiting. Indeed, embodiments of the present disclosure are capable of hosting service modules which have not yet been conceptualized, and such modules may be added as they are developed or required. Similarly, modules may be omitted where not required. A NET4AI module 112 provides a NET4AI service; a NET4Data module 114 provides a NET4Data service; a NET4BC module 116 provides a NET4BC service; a DAM module 118 provides a DAM service; one or more vertical modules 120 provide one or more associated vertical services; and a connectivity service module 122 provides a connectivity service. Descriptions of each of these modules are provided below. Each module can be provided (e.g. operated) by a different party, or multiple modules can be provided (e.g. operated) by the same party. A service module (e.g. any of the above-mentioned service modules) may provide or offer a service (e.g. NET4AI service, NET4Data service, NET4BC service, DAM service, vertical services, connectivity service) to an end customer (user), to one or more M/C modules in the M/C layer 130, or to other service modules in the service layer 110, or a combination thereof. Service modules can provide services to other service modules in a substantially arbitrary chain or web of interconnections. In various embodiments, any given service module can potentially be provided as a service to any other given service module (in the same layer or another layer) or to an external user or customer.

The NET4AI (network for artificial intelligence) service provided by the NET4AI module 112 may be described as follows. The NET4AI service provides some or all of: artificial intelligence (AI) model customization and management, AI model distribution and parallelization, AI model training, and inferencing optimization. The NET4AI module facilitates providing AI as a service. AI as a service can refer to a service by which AI or machine learning resources can be provided for use by an end user or other service module or any of the M/C modules 130.

The NET4Data (network for data) service provided by the NET4Data module 114 may be described as follows. The NET4Data service provides some or all of: data upload and data storage, data access control and data protection. The NET4Data module facilitates providing data storage (e.g. cloud storage) as a service. Data storage as a service may be deployed to handle an end user's data or the data of another one of the service modules 110 or any of the M/C modules 130. The NET4Data service may store data in one or more computer memories, and may manage features such as data integrity and backup, data redundancy, data retrieval speed optimization, etc. The NET4Data service may also provide for data sharing.

The NET4BC (network for blockchain) service provided by the NET4BC module 116 may be described as follows. The NETBC service provides generic management and control of block chain operations. The NET4BC service handles block data and enables block chain as a service.

The DAM (data analytics and management) service provided by the DAM module 118 may be described as follows. The DAM service provides some or all of: data collection and verification, data privacy protection, data analysis, and data delivery. The DAM service handles all types of data and enables data analytics and management as a service. The DAM service may also provide for data sanitization.

Vertical services provided by the vertical module(s) 120 may include a vehicle to everything (V2X) service, an Internet-of-Things (IoT) service, a metaverse service, etc. Handling vertical (e.g. V2X, Metaverse) customer's data traffic. A vertical service may generally be described as a service which is associated with a vertical service provider. A vertical service provider may provide one or more specialized products or services in a particular niche. Examples of vertical service niches include banking, manufacturing, education, real estate, government or law.

The connectivity service provided by the connectivity service module 122 may facilitate provisioning of data connectivity between devices or endpoints. For example, data connectivity may be provisioned between a device and a data network (DN), between two application services or servers, or the like. The connectivity service may facilitate providing data connectivity as a service. In various embodiments, the connectivity service may handle end user's data traffic, such as voice traffic or application layer data. The connectivity service may include a 6G connectivity service. In some embodiments, the connectivity service module 122 is integrated with the mission management module 140. For example, the connectivity service module 122 may be integrated within the mission management module 140 such that the mission management module 140 provides the connectivity service.

As used herein, a service provided by a service module in the service layer 110 may be referred to as an XaaS service. Because the service is provided at the service layer 110, it is referred to as a service layer XaaS service.

A service module may include one or multiple network functions. A service module may provide an associated service using these network functions. When the service module includes only one network function, the service module may be equated with (or may be) this included network function.

In various embodiments, a service has its own data process which is implemented by some or all of the one or multiple network functions of the service module. Data processes may include computing or data processing, data storage, block creation, data de-privacy operations, etc.

The M/C layer 130, (which may also be referred to as the control and management (C/M) layer) includes one or multiple M/C modules.

By way of example, FIG. 1A illustrates a variety of possible M/C modules. These examples are not necessarily intended to be limiting. A resource management (RM) module 132 provides a RM service. A protocol management (PM) module 134 provides a PM service. A connectivity management (CM) module 136 provides a connectivity service. A policy and customer service management (CSM) module 138 provides a policy and CSM service. A mission management (MM) module 140 provides a MM service, where missions are as described elsewhere herein. A confederation of networks (CONET) module 142 provides a CONET service. A network security management (NSM) module 144 provides a NSM service. Each M/C module can be provided by a different party. One or more M/C modules can be provided by the same party. An M/C module (e.g. any of the above-mentioned M/C modules) may provide an M/C service (e.g. RM service, PM service, CM service, CSM service, CONET service, NSM service) to an end customer (user) (which may be an external customer or user), to one or more infrastructure modules in the infrastructure layer 150, to one or more of the service modules in the service layer 110, to other M/C modules in the M/C layer 130, or the like, or a combination thereof.

The RM service provided by the RM module 132 may be described as follows. The RM service may manage resources in a static way or a dynamic way. The managed resources may include resources provided by the infrastructure layer, such as wireless resources, wireline resources, computing resources, storage resources, and sensing resources. Managing resources may include managing and controlling network slicing and data routing. The RM service may provide a capability of life-cycle management of one or more network slices and over-the-air resource assignments to wireless devices.

The PM service provided by the PM module 134 may be described as follows. The PM service may provide software-define protocol functionalities, such as packet processing function chain and configuration, protocol stack selection and configuration, protocol parameter tuning and optimization, or the like, or a combination thereof. This PM service may also be referred to as a software defined protocol (SDP) service. The PM service may provide a capability to design service customized protocol stacks for identified interfaces. The protocol stacks may be pre-defined for on-demand selection. The protocol stacks may be designed on demand.

The CM service provided by the CM module 136 may be described as follows. The CM service may provide connection management, mobility management, handover, path switching, registration management, paging, power saving management, or the like, or a combination thereof.

The CSM service provided by the CSM module 138 may be described as follows. The CSM service may provide authentication, identification (ID) management, key management (traffic protection), authorization, service level agreement (SLA) management, SLA enforcement, policy/rule/regulation assurance, installment (charging), or the like, or a combination thereof. SLA may refer to a service level agreement between any two or more of a variety of parties. For example, an SLA may be between parties operating in the service layer, parties operating in the M/C layer, parties operating in the infrastructures, or the like, or a combination thereof. Each of these parties may have one or multiple roles as described elsewhere herein for example with respect to described X-centric scenarios.

The MM service provided by the MM module 140 may be described as follows. The MM service may transform the data processes of one or more relevant service modules in the service layer to a mission, for example upon request. The MM service (more precisely, the MM module providing the MM service) may manage (e.g. establish, modify and configure) communication tunnels between the service data planes of the relevant service modules to support the mission. In some embodiments, the MM service (more precisely, the MM module 140 providing the MM service) may invoke (i.e. use) the connectivity service (provided by the connectivity service module 122) to manage (e.g. establish, modify and configure) communication tunnels between the service data planes of the relevant service modules to support the mission, and the connectivity service (more precisely, the connectivity service module 122 providing the connectivity service) manages the communication tunnels correspondingly. Missions may be as described elsewhere herein, for example in relation to cross-layer, cross-service interactions. A mission may be a service provided to customers. A mission may be a type of service which is provided by a single service or using contributions from multiple services. The MM service provides a capability to program provisioning of XaaS services at the service layer to provide mission services. In some embodiments, the MM module 140 is integrated with the connectivity service module 122, for example, integrated within the connectivity service module 122 such that the connectivity service module 122 provides the MM service.

The CONET service provided by the CONET module 142 may be described as follows. The CONET service may provide or facilitate trust consortium establishment, consortium member joining or leaving, block chain management including creation, update and deletion. The CONET service may also be referred to as a block chain for network (BC4NET) service. CONET refers to a confederation network. The CONET service may involve or facilitate confederation formulation, mutual authentication, mutual authorization among partners and negotiation of agreement on recording and retracing of selected actions performed by such partners. This may be performed in order to provide for a trustworthy environment of system operations.

The NSM service provided by the NSM module 144 may be described as follows. The NSM service may provide or facilitate equipment operation security risk detection, network operation security risk detection, network operation security risk prediction, or the like, or a combination thereof. The NSM service may also be referred to as security for network (SEC4NET) service. The NSM module 144 provides network security as a service. This may provide a capability for infrastructure owners to detect potential security risks of or to their infrastructure assets, for example.

In various embodiments, an M/C service provided by an M/C module may be an XaaS service. Because the service is provided at the M/C layer, it may be referred to as an M/C layer XaaS service.

In various embodiments, the M/C module comprises one or multiple network functions and provides the M/C service using these network functions. When providing the M/C service, the M/C module may utilize service-layer XaaS services. When the M/C module includes only one network function, the M/C module may be equated with (or may be) this network function.

In various embodiments, the M/C service has its own signaling process which is implemented by some of the one or multiple network functions of the M/C module. The signaling processes may include, for example, management signaling, control signaling, or the like, or a combination thereof.

The infrastructure layer 150 includes one or more infrastructure modules. The infrastructure modules may provide or offer diversified infrastructure resources. The infrastructure modules may include terrestrial communication modules 152. Examples of terrestrial communication modules include a radio access network (RAN) module, a reconfigurable intelligent surfaces (RIS) module, a zero energy devices (ZED) module, and a transport network (TN) module. The infrastructure modules may include non-terrestrial communication modules 154, such as satellite network communication modules. The infrastructure modules may include cloud modules 156, such as data center networks. The infrastructure modules may include caching modules 158, such as caching nodes. The infrastructure modules may include sensor modules 160, such as sensor nodes or sensor networks.

Each infrastructure module can be provided by a different party, or multiple infrastructure modules can be provided by the same party. Providing may include providing and operating a module, or operating an already provided module. An infrastructure module (e.g. any of the above-mentioned infrastructure modules) may provide an infrastructure service (in the form resources) to an end customer (user), to the service layer or module thereof, to the M/C layer or module thereof, to other infrastructure modules in the infrastructure layer, or the like, or a combination thereof. The infrastructure service provided by an infrastructure module may be referred to as an infrastructure layer XaaS service. Each infrastructure module, or the plurality of infrastructure modules, may be provided by a single provider or by multiple providers.

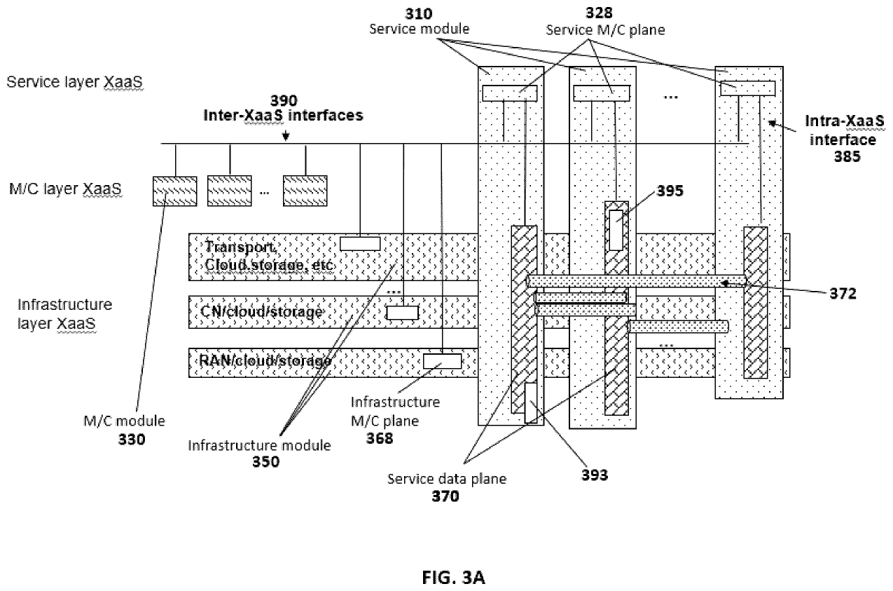

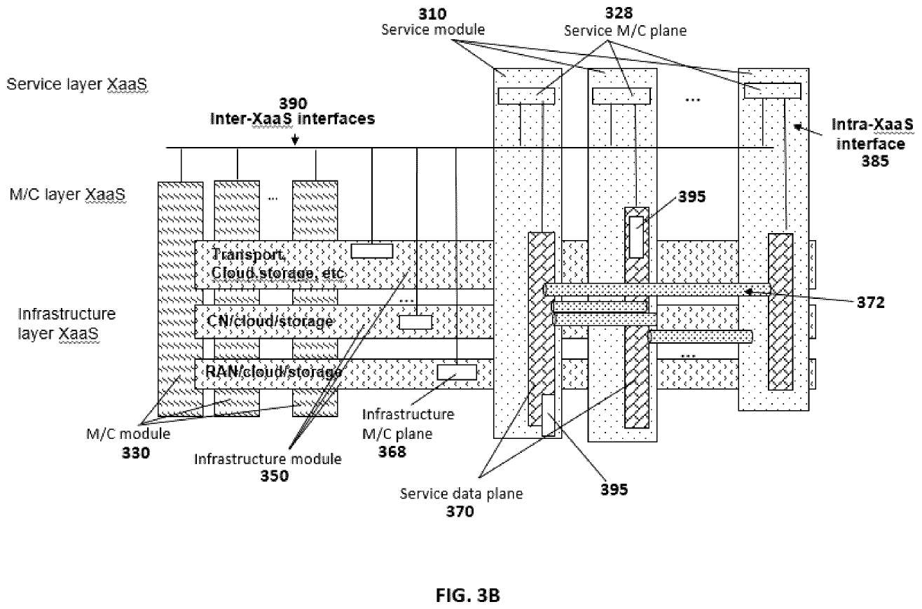

As also illustrated in FIG. 1A, each service module in the service layer 110 may include or be operatively coupled to its own respective service M/C plane component 128. Similarly, each infrastructure module in the infrastructure layer 150 may include or be operatively coupled to its own respective infrastructure M/C plane component 168. Such M/C plane components are described in more detail with respect to FIG. 3A, and in this respect, it is noted that the components 128, 168 of FIG. 1A may be the same as components 328, 368 of FIG. 3A, respectively. The M/C plane components 128, 168 may be dedicated control functions for the module to which it is associated. In various embodiments, each M/C plane component 128, 168 is connected to each other M/C plane component 128, 168 and also to each module of the M/C layer 130. Connection may be via inter-XaaS interfaces. Each module of the M/C layer 130 may also be interconnected in this manner. Thus, a full mesh network may operatively couple all of the modules of the M/C layer and all of the M/C plane components. In a full mesh network, each one of the networked components may be directly connected to each other one of the networked components for example via a separate dedicated communication link. Accordingly, the M/C layer modules and M/C plane components can be controlled in a coordinated manner. For example, the M/C layer may control the behaviour of each service module via such a full mesh network. The M/C plane components 168 may be used for infrastructure management. Each of the illustrated infrastructure modules is a different type of infrastructure provided as a service.

FIG. 1B illustrates an embodiment having the same components as FIG. 1A, as well as some additional components, according to an embodiment. In particular, in FIG. 1B a NET4DW service module 124 is included in the service layer 110, a service provisioning management module 146 is included in the M/C layer 130, and a core network (CN) infrastructure module 162, a datacenter infrastructure module 164 and a database infrastructure module 166 are provided in the infrastructure layer 150. The CM module may provide a service to the digital world.

The RAN infrastructure module 152 and the core network (CN) infrastructure module 162 may interoperate as complementary parts of one or more wireless networks. The datacenter infrastructure module 164 may operate similarly to the cloud module 156, to provide datacenters or related capabilities. The database infrastructure module 166 may similarly provide for database-specific capabilities, for example in the form of one or more databases responsive to database queries or data storage operations.

The modules of the M/C layer 130 may be provided and deployed by using network slicing. These modules may also utilize (e.g. via network slicing) resources provided by the infrastructure layer.

The service provisioning management module 146 provides a capability of control and management of service access by customers and provisioning of requested services. This capability may be provided using unified mutual authentication, authorization and policy, key management, QoS assurance and charging between any pair of XaaS service provider and customer. Customers in this sense may include end customers in the physical world, and digital representatives in the digital world, or both.

In various embodiments, XaaS services in the M/C layer 130 support control and management of the 6G System itself, and also provide support to verticals if requested. One example is that the RM service 132 can serve RAN for over-the-air resource management and can also provide service to a vertical for the vertical's over-the-air resource allocation to its end-customers. The XaaS modules in the M/C layer 130 can be deployed by using slicing techniques.

The NET4DW service module 124 provides digital world functionality and related services. The digital world functionality and related services (i.e. the digital world services in short) provide a capability to construct, control and manage a digital world. The digital world is defined as a digital realization of the physical world. Digital world, for example Metaverse, provides an interactive, multi-user environment which is intended to emulate various physical aspects of the real world. Sensors may be used to obtain digital world participant data, and the digital world may react to this sensor input, for example by providing corresponding outputs to the participant or other remote participants, in order to make the user experience immersive. The NET4DW service module may handle digital world participant data in order to facilitate such an experience, obtain and utilize network resources to facilitate the experience to a desired quality, manage participation, direct user experiences, etc.

The services provided at the service layer 110 may be developed and deployed by using resource provided in infrastructure and utilizing Network Function Virtualization and Slicing techniques. The capability of each of service may be provided by its control and management functions and service specific data process functions.

In addition to supporting XaaS services at the service layer 110, 6G embodiments may leverage 5G system for provisioning of vertical services (see also 120). A difference between 6G XaaS services and other verticals are that a vertical is a pure customer which needs other XaaS services to enable its operation, while each of XaaS services provide their capabilities to 6G customers.

In various embodiments, an arbitrary pair of XaaS services of the 6G System may be the mutual customer and provider of one another. A first service may have a second service as a direct or indirect customer, and the first service may also be a direct or indirect customer to the second service. A first service may rely on other services directly or indirectly, which in turn rely on the first service directly or indirectly. An indirect customer is a customer of a customer, for example. As examples, an infrastructure owner may provide its resource to XaaS services in Service Layer and C/M Layer; RM services may use the capabilities provided by NET4AI, DAM and NET4DW for its resource management for vertical slicing; CONET service and NET4Data service may use the capability provided by NET4BC for their operation.

The use of modules, such as service modules, M/C modules and infrastructure modules, may facilitate a customizability of the architecture as disclosed herein. Modules can be provided on an as-needed basis, with unnecessary modules omitted. This can streamline and simplify implementation of the architecture. Furthermore, as future services become available, they can be encapsulated in new modules and added on an as-needed basis. Each module may be substantially self-contained and interoperate with other modules or system components using a defined interface or protocol. Thus, adding a module or removing a module can be done without necessarily reconfiguring the other modules. This facilitates a ready reconfigurability of the architecture.

Different system modules as described above (e.g. service modules, M/C modules, infrastructure modules) may be provided by different parties. Parties can be business entities, “players”, etc. A business entity can be focused on providing one or more products or services, for example communications or computing infrastructure, software services, applications, utilities, consulting, government, or the like, or a combination thereof. Three different roles that can be taken on by a party include: service layer XaaS provider, M/C layer XaaS provider, and infrastructure layer XaaS provider. A party providing at least one service module at the service layer takes on the service layer XaaS provider role. A party providing at least one M/C module at the M/C layer takes on the M/C layer XaaS provider role. A party providing at least one infrastructure module takes on the infrastructure layer XaaS provider role. A party may provide modules at more than one layer, thus taking on multiple roles.

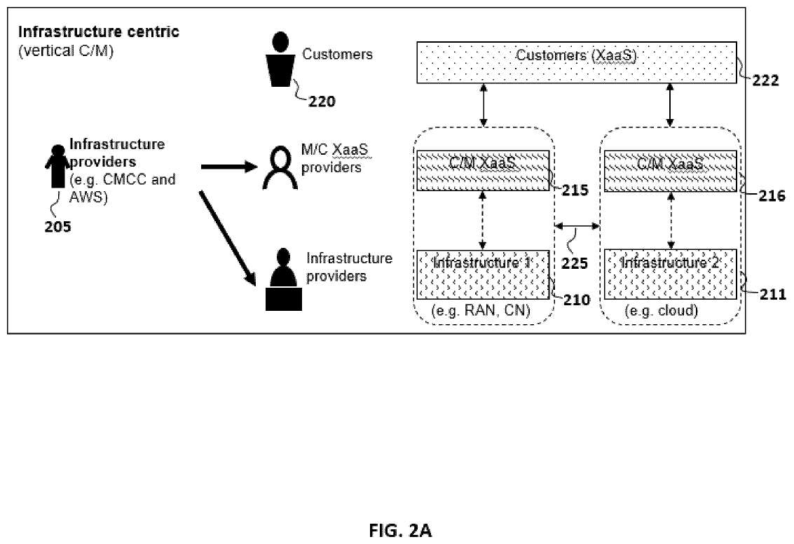

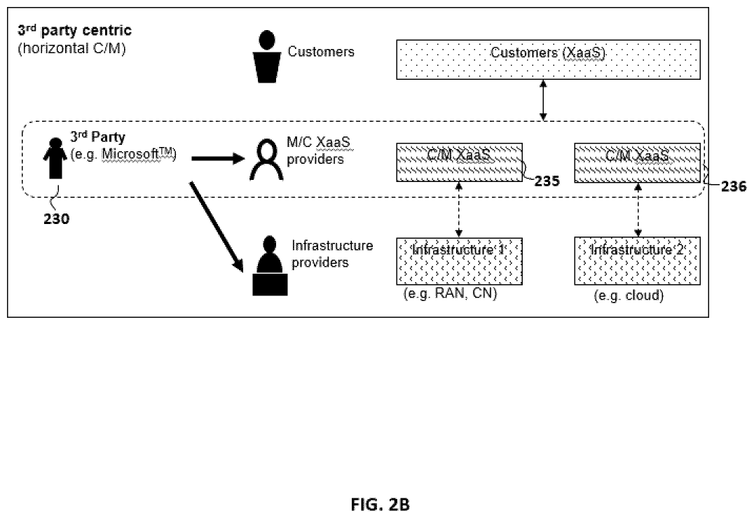

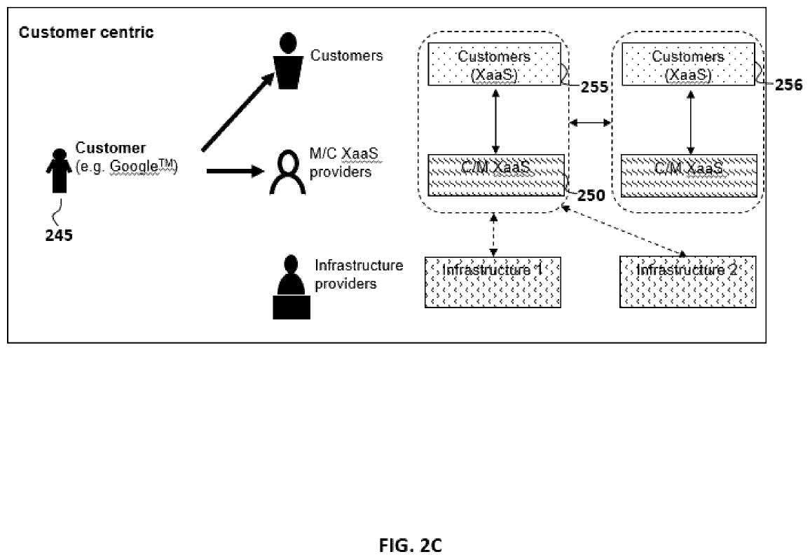

As shown in FIGS. 2A to 2C, three possible scenarios are illustrated, depending on which party assumes the M/C layer XaaS provider role. In FIGS. 2A to 2C, an infrastructure provider is an infrastructure layer XaaS provider, an M/C XaaS provider is an M/C layer XaaS provider, a customer is a service layer XaaS provider, a third party is neither a service layer XaaS provider nor an infrastructure layer XaaS provider. The data plane interface is not illustrated in FIGS. 2A to 2C.

FIG. 2A illustrates an infrastructure-provider centric scenario, according to embodiments of the present disclosure, in which one or more parties 205 (infrastructure providers) providing portions 210, 211 of the infrastructure layer each also provides at least one component (module) 215, 216 of the M/C layer. This may also be referred to as a “vertical M/C” scenario. In the infrastructure-provider centric scenario, an infrastructure layer XaaS provider also assumes the M/C layer XaaS provider role. Different infrastructure providers may interact with each other, as illustrated by horizontal arrows 225. Similarly, modules associated with a first infrastructure provider may interact with modules associated with a second, different infrastructure provider. One infrastructure provider may provide modules 210, 215, while another infrastructure provider may provide modules 211, 216. Customers 220 may provide modules in the service layer 222, or another entity may provide the modules 222 for use by the customers.

FIG. 2B illustrates a third-party centric scenario, according to an embodiment of the present disclosure, in which a third party 230 provides components 235, 236 (e.g. modules) of the M/C layer and thus assumes the M/C layer XaaS provider role. This may also be referred to as a “horizontal M/C” scenario. The 3rd party may provide one, or multiple ones, or all of, the components of the M/C layer. Components (e.g. modules) of the infrastructure layer may be provided by infrastructure providers. Components (e.g. modules) of the service layer may be provided by customers or other entities.

FIG. 2C illustrates a customer centric scenario, according to an embodiment of the present disclosure, in which one or more customers 245 provides components 250, 255, 256 of the M/C layer and thus assumes the M/C layer XaaS provider role. Such customers 245 also provide one or more components 255, 256 of the service layer. One customer may provide one or some components 250 (modules) of the M/C layer and one or some components 255 (modules) of the service layer, while another customer may provide other components 256 of the service layer (and optionally also of the M/C layer). Components (modules) of the infrastructure layer may be provided by infrastructure providers.

It is noted that the scenarios illustrated in FIGS. 2A to 2C may occur as illustrated, or the scenarios may be combined arbitrarily to produce hybrid scenarios. Scenarios may be configured on an as-needed basis. Scenarios may be negotiated between the involved parties. Accordingly, embodiments are X-centric. The term “X-centric” refers to the capability of embodiments to be reconfigurable so that they are either infrastructure-provider centric, third-party centric, customer centric, or the like, or a combination thereof. Other types of configurations may also be supported. Multiple possible mappings between parties and roles are thus supported, with different X-centric scenarios corresponding to different mappings. This facilitates an architectural openness with support for multiple operation scenarios. A configuration may be centric to a certain entity in that the configuration is directed toward a certain goal related to that entity. An architecture may be X-centric in that it may be configurable to any of a variety of such configurations.

Embodiments of the present disclosure also exhibit cross-layer interaction, cross-service interaction, or both. FIG. 3A illustrates an embodiment of the present disclosure, in which a service module 310 includes (or is associated with) a service M/C plane component 328 and a service data plane 370. The service M/C plane component 328 may implement functionalities of the M/C layer for managing and controlling the service data plane 370. Each service M/C plane component 328 and service data plane 370 may be dedicated to a single particular service module 310. The service M/C plane component 328 (or simply service M/C plane, or M/C plane) may include one or multiple network functions (referred to as controllers). The service data plane 370 (or simply data plane) may also include one or multiple network functions (referred to as processing functions). These network functions may be logical functions and can be dynamically deployed. The service modules 310 may be the same as the service modules of the service layer 110 of FIG. 1A.

In various embodiments, one or both of two types of processing functions may be included in the service data plane 370. These two types of processing functions are data processing functions and header processing functions. Data processing functions implement service-specific logic and processes service data, e.g. for the purpose of AI training, data sanitization, private data access control, integration of multiple streams for meta-verse, etc. Header processing functions implement connection/communication logic and perform header processing, e.g. for the purpose of routing, QoS handling, traffic detection, traffic gating, etc. The service data plane 370 may accordingly be further divided into a processing plane and a connection plane. The processing plane includes the data processing functions. The connection plane includes the header processing functions. In some embodiments, the service data plane 370 includes only data processing functions, and the connection plane is optional. In some embodiments, the service data plane 370 includes only header processing functions, and the processing plane is optional, for example, when the service module 310 is a connectivity service module, such as the connectivity service module 122. A service data plane 370 may be dedicated to a particular host service and may handle the data which is required for providing the service.

The service modules 310 may be provided using, or supported by, infrastructure modules 350, which may be the same as the infrastructure modules of the infrastructure layer 150 of FIG. 1A. The infrastructure modules 350 may for example be provided as a service for implementing the service modules 310. Thus, according to the XaaS approach, modules may be implemented or supported at least in part using infrastructure modules. A service module (or service layer XaaS) may use one, some or all types of available infrastructure modules (or infrastructure layer XaaS).

In various embodiments, when a service module 310 offers an XaaS service, associated processing function(s) may receive service data from each other, or from other network functions (e.g. a service data plane of another service module). Such processing functions may process received data traffic carrying data (service data) related to the service that the service module offers. Such processing functions may additionally or alternatively transmit service data (which may be the processed service data and which may be included in a processed data traffic for transmission) to each other or to other network function(s). For example, processing functions may transmit service data to processing function(s) of a different service module using one or multiple interconnections 372. The data traffic (whether received or transmitted) may include information indicating a type of the service data, e.g. data for process, AI model, pre-sanitized data, post-sanitized data, etc. The data traffic may further include information identifying how the service data should be processed, e.g. a process code or index. The data traffic may include information such as source entity ID, destination ID, path ID or sequence of process, etc., and the information may then be used by the processing functions to route the data traffic properly (e.g. using the right path). The information described above may be included in a data packet, e.g. in the header of the data packet or in the payload field of the data packet (e.g. as part of the service data). The data packet belongs to the data traffic.

In various embodiments, a service M/C component 328 includes one or more controllers, and a service data plane 370 includes one or more processing functions. The one or more controllers manage or control the one or more processing functions using one or more intra-XaaS interfaces 385. The intra-XaaS interfaces may facilitate operative coupling between the service M/C plane component 328 and the service data plane 370. The service data plane 370 and the service M/C component 328 may belong to the same service module. Each of the one or more controllers may manage or control one or multiple ones of the one or more processing functions. Examples of such a controller managing or controlling such a processing function include: determining or configuring location (network location) of the processing function, determining or configuring interconnection between multiple processing functions, determining or configuring operation parameters of a processing function, or the like. Such control may be performed to facilitate or ensure satisfactory or optimal performance of the XaaS service.

At least one infrastructure module 350 includes (or is associated with) an infrastructure M/C plane component 368 (also referred to as an infrastructure M/C plane), which may be the same as the infrastructure M/C plane component 168 of FIG. 1A. The infrastructure module 350 may be located at the infrastructure layer 150. The infrastructure modules 350 may be the same as the infrastructure modules of the infrastructure layer 150 of FIG. 1A. The M/C plane components, the service M/C plane components, or both, may be provided using services of one or more of the infrastructure modules.

The infrastructure M/C plane component 368 may implement functionalities of the M/C layer for managing and controlling the resources provided by its associated infrastructure module 350. The infrastructure M/C plane component 368 (or simply M/C plane) includes one or multiple network functions (also referred to as controllers). These network functions may be logical functions and can be dynamically deployed.

The service data planes 370 of one, some or all of the service modules 310 can be interconnected via interconnections 372. The interconnections 372 may be in the form of tunnels. The interconnections can be used to facilitate providing the functionality of one service module as a service to another service module. The interconnections can be used to form an interconnected plurality of service modules, referred to as a graph. The interconnections can be provided as a service by one or more of the infrastructure modules. Some service modules can be interconnected in this manner, while others are not, thus influencing the topology of the graph, for example on an as-needed basis to support a given operating scenario. Devices (terminals), application servers (AS), or the like can be attached or connected to the graph via further operative links, on an as-needed basis. For example, terminals 393 can be connected to one service data plane 370, and an AS 395 can be connected to another service data plane 370. Multiple types of tunnels may pass through a subset of service layer XaaS service data planes. The interconnections 372 may be managed (e.g. established, modified, configured) by the MM service (which is provided by the mission management module 140) or the connectivity service (which is provided by the connectivity service module 122).

In various embodiments, at least one service module in the service layer may have its own data plane. In some embodiments, each service module may have its own data plane. The data planes of the service modules in the service layer can be connected together by interconnections, which may be an arbitrary type of tunnel. This facilitates flexible data plane connections.

In various embodiments, service data is transmitted on the graph and processed by one or more service data planes of one or more service modules, so that a data processing purpose is achieved. The data processing purpose is referred to as a mission. Examples of missions include training an AI model, and collecting and analyzing data. Different missions may involve different service modules. Two or more service modules may cooperate to fulfill a mission. In some embodiments, a mission may involve only one service module. A mission may be created or requested by an end customer or by the M/C layer or M/C module thereof. The use of missions can potentially support complicated processing logic, openness, and extensibility. Terminals, ASs, or both, can participate in data processing for a mission. This allows terminal devices and ASs to contribute to computing and processing tasks that occur in a network. For example, the terminal devices or ASs may operate to support a specified mission for example as managed by an MM module and involving one, two or more service modules.

For example, referring again to FIG. 3A, a mission may involve multiple service modules 310. The related data processing may span the service data planes 370 of these multiple service modules. The interconnections 372 may facilitate communication between these multiple service modules to facilitate the data processing.

In various embodiments, the M/C planes 328 of service modules 310 in the service layer (e.g. service layer 110 of FIG. 1A), the M/C planes 368 of infrastructure modules 350 in the infrastructure layer (e.g. infrastructure layer 150 of FIG. 1A), and the M/C modules 330 in the M/C layer (e.g. M/C layer 130 of FIG. 1A) are communicatively coupled to one another. The communicative coupling can be provided in the form of a full mesh, such that any two entities (M/C planes M/C modules) can communicate directly. This full mesh interconnection may involve the entities being connected to a communication bus, which (or components of which) may be referred to as inter-XaaS interfaces 390. Alternatively, interconnection may be partial, so that some entities may have to communicate with one another via another entity acting as a relay. The inter-XaaS interfaces 390 between modules, potentially forming a full mesh structure, allows any two system modules to interact at the M/C level to facilitate making optimal decisions, consistent M/C decisions, or a combination thereof. The inter-XaaS interfaces or associated communication bus may be provided as a service by one or more of the infrastructure modules, or by using services of the one or more infrastructure modules. A communication bus may directly connect components via a common and shared link (the bus).

The M/C modules 330 can provide information regarding network dynamics to the controllers. This information can include, for example, an indication of a device accessing to or leaving from a mission, a mission requirement change, a resource availability change, etc. The information may influence or control the service M/C planes' decisions regarding managing or controlling respective processing functions in service data planes of the service modules, on a per mission basis. For example, a controller in a service M/C plane may base such decisions at least in part on the information received from the M/C layer. As such, the M/C layer can manage, control, or coordinate the behavior of each service module in the service layer according to network dynamics so that the service layer can provide a desirably good or best overall performance for each mission.

FIG. 3B is the same as FIG. 3A, except that the M/C modules 330 are extended in size to emphasize that they can utilize resources (provided as a service) of one, some or all of the infrastructure modules 350 in their operation. More generally, as already explained above, each module may utilize resources (provided as a service) of one, some or all of the other modules. Similarly, components of a service M/C plane 328, service data plane 370, or other components, can utilize resources of one or more other modules (provided as a service) in their operations. Tunnels, interfaces or interconnections may similarly utilize resources of one or more other modules (provided as a service) in their operations.

According to various embodiments, multiple different types of traffic may be present in a system. These traffic types can be carried by the data plane (e.g. service data plane 370), the M/C plane (e.g. service M/C plane 328), or both. One, some or all of the different modules (including service modules, M/C modules and infrastructure modules) may carry one or more different traffic types. A traffic type may be specific to a type of module, or generic to two or more types of modules. For example, a NET4AI service module may carry data traffic for training AI models. A DAM service module may carry traffic of raw collected data, post-sanitized data, and post-analyzed data. A NET4Data service may carry a variety of data of data owners. The data owners may include end customers and providers of other XaaS services. A NET4DW service can carry data between points in a digital world. A NET4BC service can carry data blocks of block chains.

According to various embodiments, the data plane (e.g. service data plane 370) may include a collection of data processing functions of XaaS services in the service layer. Such data processing functions may be new to the 6G services of the service layer, and at least some may be different from 5G user plane functions (UPF).

According to various embodiments, the M/C plane (e.g. service M/C plane 328) may include a collection of M/C functions of XaaS services.

Various embodiments of the present disclosure support multiple operation modes. Various embodiments enable or facilitate an open environment to allow multiple partners to jointly provide XaaS services. Partners may be providers of 6G system infrastructures and 3rd parties that are neither customers, nor infrastructure providers. In various embodiments, each provider of XaaS services is defined as a role. The system allows flexible mapping between partners and roles of the 6G System. An infrastructure provider may presume all roles of the 6G System using its infrastructures including network infrastructure, data centers and storage infrastructures. An infrastructure provider may presume only some of roles and allow 3rd parties provide other XaaS services. An infrastructure provider can provide infrastructure as a service, at the same time, the provider can be a vertical customer of the system. The flexible mapping between partners and roles enables the 6G System to adapt to a variety of 6G System operation modes to meet different business capability and interests.

According to various embodiments, modules providing a functionality as a service to other modules are a part of a communication network. As such, the modules include communication functionality, and utilize communication network infrastructure, in addition to providing other potential functionality such as data processing or data storage. A module providing functionality as a service may provide the entire functionality to its client(s) without the clients needing to perform further management tasks. Instead, the functionality is provided in response to request messages, for example. Modules providing a first service may rely on other modules providing other services, in order to deliver the first service, or in order to maintain its functioning, or the like. Modules may be interdependent on one another, for example in a closed system of interdependence, via the provision of services to one another.

In embodiments, the XaaS model facilitates network customization and reconfiguration. New modules can be added without reconfiguring existing modules. Networks can be deployed only with the required modules, and modules can be scaled up or down depending on requirements.

According to various embodiments, modules are provided at a certain level of granularity. This may be in addition to the modules being of three types: service modules, M/C modules, and infrastructure modules. The level of granularity is such that there are neither too many different modules (which would lead to high complexity) nor too few modules (which would lead to high generality of each module type). Accordingly, in various embodiment, each module is configured to provide one and only one overall general function as a service. This function is unique and completely provided by the module (with the module relying on other modules to provide services thereto as necessary). The module is thus self-contained from the perspective of clients which use the module to access the provided service.

According to embodiments, a service module (for example) includes all of the sub-components necessary for it to receive and respond to service requests (from clients) by performing a requested service. For example, the service module may include components in a service M/C plane and a service data plane, which together perform all of the required operations of the service module. The service data plane may include sub-modules (e.g. computer processor sub-modules, data storage modules, real-world interface modules, etc.) which perform various functionalities as required by the service module. The service data plane may further include interfaces or interconnections between such sub-modules.

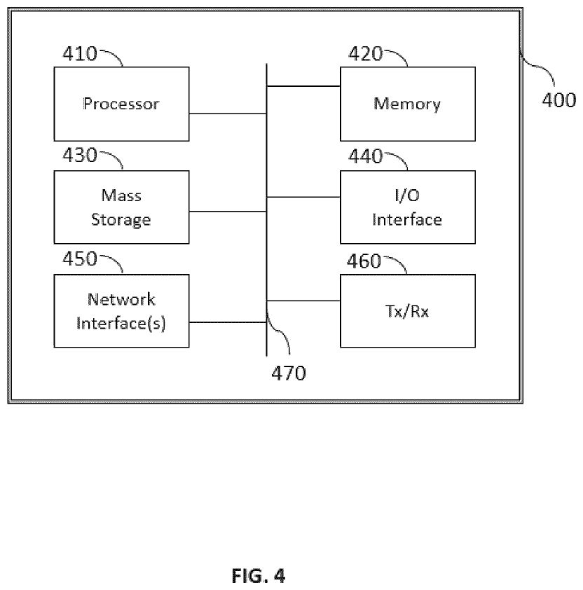

FIG. 4 is a schematic diagram of a computing device 400 that may perform any or all of operations of the methods and features explicitly or implicitly described herein, according to different embodiments of the present disclosure. For example, a computer equipped with network function may be configured as the computing device 400. One, two or more such computing devices may be coupled together in order to provide embodiments of the present disclosure. Multiple physically separate devices (e.g. in the same or separate datacenters) may be coupled together in order to provide one, two or more of such computing devices. When a device provides an infrastructure module, that device may consist primarily of an associated resource. For example, a computing module may consist primarily of computer processors, while a storage module may consist primarily of computer memory.

As shown, the device 400 may include a processor 410, such as a Central Processing Unit (CPU) or specialized processors such as a Graphics Processing Unit (GPU) or other such processor unit, memory 420, non-transitory mass storage 430, input-output interface 440, network interface 450, and a transceiver 460, all of which are communicatively coupled via bi-directional bus 470. According to certain embodiments, any or all of the depicted elements may be utilized, or only a subset of the elements. Further, device 400 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 420 may include any type of non-transitory memory such as static random access memory (SRAM), dynamic random access memory (DRAM), synchronous DRAM (SDRAM), read-only memory (ROM), any combination of such, or the like. The mass storage element 1130 may include any type of non-transitory storage device, such as a solid state drive, hard disk drive, a magnetic disk drive, an optical disk drive, USB drive, or any computer program product configured to store data and machine executable program code. According to certain embodiments, the memory 420 or mass storage 430 may have recorded thereon statements and instructions executable by the processor 410 for performing any of the aforementioned method operations described above.

Embodiments of the present disclosure can be implemented using electronics hardware, software, or a combination thereof. In some embodiments, the disclosure is implemented by one or multiple computer processors executing program instructions stored in memory. In some embodiments, the disclosure is implemented partially or fully in hardware, for example using one or more field programmable gate arrays (FPGAs) or application specific integrated circuits (ASICs) to rapidly perform processing operations.

It will be appreciated that, although specific embodiments of the disclosure have been described herein for purposes of illustration, various modifications may be made without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the disclosure to provide a computer program product or program element, or a program storage or memory device such as a magnetic or optical wire, tape or disc, or the like, for storing signals readable by a machine, for controlling the operation of a computer according to the method of the disclosure and/or to structure some or all of its components in accordance with the system of the disclosure.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present disclosure and invention(s) associated therewith have been described with reference to specific features and embodiments, it is evident that various modifications and combinations can be made thereto without departing from such invention(s). The specification and drawings are, accordingly, to be regarded simply as an illustration of embodiments of the disclosure, for example as defined by the appended claims, and are contemplated to cover any and all modifications, variations, combinations or equivalents that fall within the scope of the present disclosure and its invention(s).

1. A networked communication system comprising:
one or more infrastructure modules each providing a respective infrastructure resource as service, each infrastructure resource comprising a respective type of device for supporting the networked communication system;
one or more service modules each providing a respective functionality as service and utilizing services of at least one of the infrastructure modules; and
one or more management and control modules each providing a respective management or control function as service and utilizing services of at least one of the infrastructure modules, at least one of the management and control modules providing said respective management or control function as service to at least one of the infrastructure modules, at least one of the service modules, or both,
wherein the one or more service modules include a connectivity service module configured to provide a connectivity service, and/or the one or more management and control modules include a mission management module configured to provide a mission management service.

2. The system of claim 1, wherein each one of the service modules comprises its own respective service management and control plane component, each one of the infrastructure modules comprises its own respective infrastructure management and control plane component, and wherein the management and control modules, the service management and control plane components, and the infrastructure management and control plane components are operatively coupled together via interconnections.

3. The system of claim 1, wherein at least one of the service modules comprises a service management and control plane component and a service data plane component operatively coupled to the service management and control plane component.

4. The system of claim 3, wherein the service management and control plane component is provided at least in part using one or more of said management and control modules as service.

5. The system of claim 3, wherein two or more of the service data plane components of two or more of the service modules are communicatively coupled together via respective interconnections.

6. The system of claim 5, wherein the interconnections are managed by the connectivity service module or the mission management module, or a combination thereof.

7. The system of claim 1, wherein each one of the service modules comprises its own respective service management and control plane component, and wherein the service management and control plane components are operatively coupled together, or the management and control modules are operatively coupled together, or the service management and control plane components are operatively coupled to the management and control modules, or a combination thereof.

8. The system of claim 1, wherein the management and control modules comprise a mission management module configured to interoperate with one or more of the service modules to perform a mission, said mission comprising a set of tasks or operations.

9. The system of claim 8, wherein the mission management module interoperates with two or more of the service modules to perform the mission, and wherein the mission management module causes one or more interconnections to be established between said two or more of the service modules in support of the mission.

10. The system of claim 8, wherein one or more terminals, application servers, or both, are operatively coupled to said one or more of the service modules and operate to support the mission.

11. A method comprising:
providing one or more infrastructure resources as service, using a respective one or more infrastructure modules, each infrastructure resource comprising a respective type of device for supporting a networked communication system;
providing one or more functionalities as service, using a respective one or more service modules, at least one service module utilizing services of at least one of the infrastructure modules; and
providing one or more management or control functions as service using a one or more management and control modules, at least one of the management and control modules providing said respective management or control function as service to at least one of the infrastructure modules at least one of the service modules, or both,
wherein the one or more service modules includes a connectivity service module configured to provide a connectivity service, the one or more management and control modules includes a mission management module configured to provide a mission management service, or both.

12. The method of claim 11, wherein each one of the service modules comprises its own respective service management and control plane component, each one of the infrastructure modules comprises its own respective infrastructure management and control plane component, and wherein the management and control modules, the service management and control plane components, and the infrastructure management and control plane components are operatively coupled together via interconnections.

13. The method of claim 11, wherein at least one of the service modules comprises a service management and control plane component and a service data plane component operatively coupled to the service management and control plane component.

14. The method of claim 13, wherein the service management and control plane component is provided at least in part using one or more of said management and control modules as service.

15. The method of claim 13, wherein two or more of the service data plane components of two or more of the service modules are communicatively coupled together via respective interconnections.

16. The method of claim 15, wherein the interconnections are managed by the connectivity service module or the mission management module, or a combination thereof.

17. The method of claims 11, wherein each one of the service modules comprises its own respective service management and control plane component, and wherein the service management and control plane components are operatively coupled together, or the management and control modules are operatively coupled together, or the service management and control plane components are operatively coupled to the management and control modules, or a combination thereof.

18. The method of claim 11, wherein the management and control modules comprise a mission management module configured to interoperate with one or more of the service modules to perform a mission, said mission comprising a set of tasks or operations.

19. The method of claim 18, wherein the mission management module interoperates with two or more of the service modules to perform the mission, and wherein the mission management module causes one or more interconnections to be established between said two or more of the service modules in support of the mission.

20. The method of claim 18, wherein one or more terminals, application servers, or both, are operatively coupled to said one or more of the service modules and operate to support the mission.
